(19) United States
(12) Patent Application Publication
(10) Pub. No.: US 2010/0095585 A1
(43) Pub. Date: Apr. 22, 2010

(54) FLOWER ARRANGING APPARATUS AND METHOD

(76) Inventor: Lori Hall, Fall City, WA (US)

Correspondence Address: LAW OFFICES OF DAVID M. LANG, 3051 Daggett Drive, Granite Bay, CA, 95746, US

(21) Appl. No.: 12/525,030

(22) PCT Filed: Feb. 14, 2008
(86) PCT No.: PCT/US08/53929

§ 371 Date: Jul. 29, 2009

Related U.S. Application Data
(60) Provisional application No. 60/890,461, filed on Feb. 16, 2007.

(51) Int. Cl. A01G 5/00

(52) U.S. Cl. 47/41.11

(57) ABSTRACT

The present invention involves a method and apparatus facilitating decorative arrangement of flowers or plants including, in one embodiment, a domed holder having a plurality of openings wherein flower or plant stems may be passed therethrough. In one embodiment the apparatus may be reversibly coupled to a vase, in another embodiment, a spherical apparatus may be utilized within the void of a vase. A spherical apparatus may be suspended for decorative appeal. A foam center may be placed within the spherical embodiment to facilitate plant hydration and stability. Alternative embodiment holders may be heart-shaped, torus-shaped, or ring-shaped, and an alternative embodiment holder may be worn as an adornment.

### CROSS-REFERENCE TO RELATED APPLICATIONS

This application claims the benefit under 35 U.S.C. §119(e), to U.S. Provisional Application 60/890,461, filed Feb. 16, 2007, entitled “EZ-Bouquet” and PCT/US08/53929 filed Feb. 14, 2008, entitled ‘Flower Arranging Apparatus and Method” the entirety of both above applications expressly incorporated herein by reference.

### FIELD OF THE INVENTION

The invention relates generally to floral products, and more generally to methods and apparatus aiding in the decorative spatial positioning of flowers or plants.

### BACKGROUND

Arranging plant products, particularly flowers, in a particular spatial pattern provides the consumer control over the aesthetic nature of decorative plants and enhances the versatility and visual appeal of a floral arrangement. Maintaining individual horticultural products in position, so that the spatial relationship between each plant is preserved, has been challenging, and several devices have been developed to meet this need.

For example, U.S. Pat. No. 6,523,301 to Delaney disclosed, in part, a floral arranging device for supporting plant stems utilizing elastic bands, oriented at angles with respect to each other, to define a plurality of interstices between the bands through which the plants stems may be inserted. U.S. Pat. No. 3,245,175 to Klingberg discloses, in part, a holder having a series of intersecting slots through which stems may be passed.

What is needed is an apparatus which is relatively inexpensive to manufacture. What is further needed is a device which optionally, may be used to arrange flowers outside the traditional vase setting. What is further needed is a flower arranging apparatus that may be placed inside a vessel or vase and anchored therein.

### SUMMARY

One aspect of the present invention provides for a flower arranging apparatus that provides the consumer optimal control over the position of the plant. Another aspect of this invention provides for an apparatus which is lightweight, durable, and easy to use. Another aspect of this invention provides for an apparatus which is easy to manufacture. Another aspect of this invention includes a domed embodiment that may be used with a variety of containers, vessels, or vases—either convexly or concavely. A spherical embodiment of the present invention permits the apparatus to be inserted and rest within vessels or vases of varied size and shape including as examples graduated vases, square, octagonal, or oval vases. Yet another aspect of this invention provides for a floral arranging apparatus embodiment which may be used as a worn adornment. An additional embodiment discloses a plant holder which may be placed upon the surface opening of a vase and optionally coupled to the lip of a vase. Yet another embodiment discloses a spherical embodiment utilized in conjunction with a foam center contained within the closed sphere, providing placed floral stems greater stability and permitting decorative suspension of the sphere by wire or string. An additional embodiment discloses a ringed half which may be used alone or in cooperation with another ringed half to form a torus; the ringed half and torus embodiments permit arrangement of a decorative floral wreath. Thus, the present inventive apparatus may be versatilely used in a variety of vessels capable of holding arranged plants or flowers.

### BRIEF DESCRIPTION OF THE DRAWINGS

FIG. 1 is a top view of an example embodiment apparatus.

FIG. 2 is a side view of an example embodiment apparatus.

FIG. 3 is a perspective view of an example embodiment apparatus.

FIG. 4 is a top view of an example half-dome embodiment apparatus.

FIG. 5 is a perspective view of an example half-dome embodiment apparatus.

FIG. 6 is a side view of an example half-dome embodiment apparatus.

FIG. 7 is a side view of an example apparatus illustrating a push-fit connection.

FIG. 8 is a perspective view of an example apparatus illustrating a push-fit connection.

FIG. 9 is an enlarged view of an example push-fit connection.

FIG. 10 is a top view of an embodiment grid-like apparatus.

FIG. 11 is a perspective view of an embodiment grid-like apparatus.

FIG. 12 is a top view of an embodiment grid-like apparatus.

FIG. 13 is a side view of an example half-dome grid-like embodiment apparatus.

FIG. 14 is a perspective view of an example half-dome grid-like embodiment apparatus.

FIG. 15 is a side view of a half-dome embodiment apparatus illustrating corresponding connections on an embodiment vase.

FIG. 16 is a top view of a half-dome embodiment in place on a vase.

FIG. 17 is a perspective view of a half-dome embodiment illustrating corresponding connections on an embodiment vase.

FIG. 18 is a perspective view of an embodiment apparatus set within a conventional vase.

FIG. 19 is a perspective view of an embodiment heart-shaped apparatus.

FIG. 20 is a top view of an embodiment heart-shaped apparatus.

FIG. 21 is a perspective view of an embodiment necklace.

FIG. 22 is a front view of an embodiment necklace.

FIG. 23 is a side view of an embodiment necklace.

FIG. 24 is a perspective view of an embodiment ringed half.

FIG. 25 is a top view of an embodiment ringed half.

### DETAILED DESCRIPTION

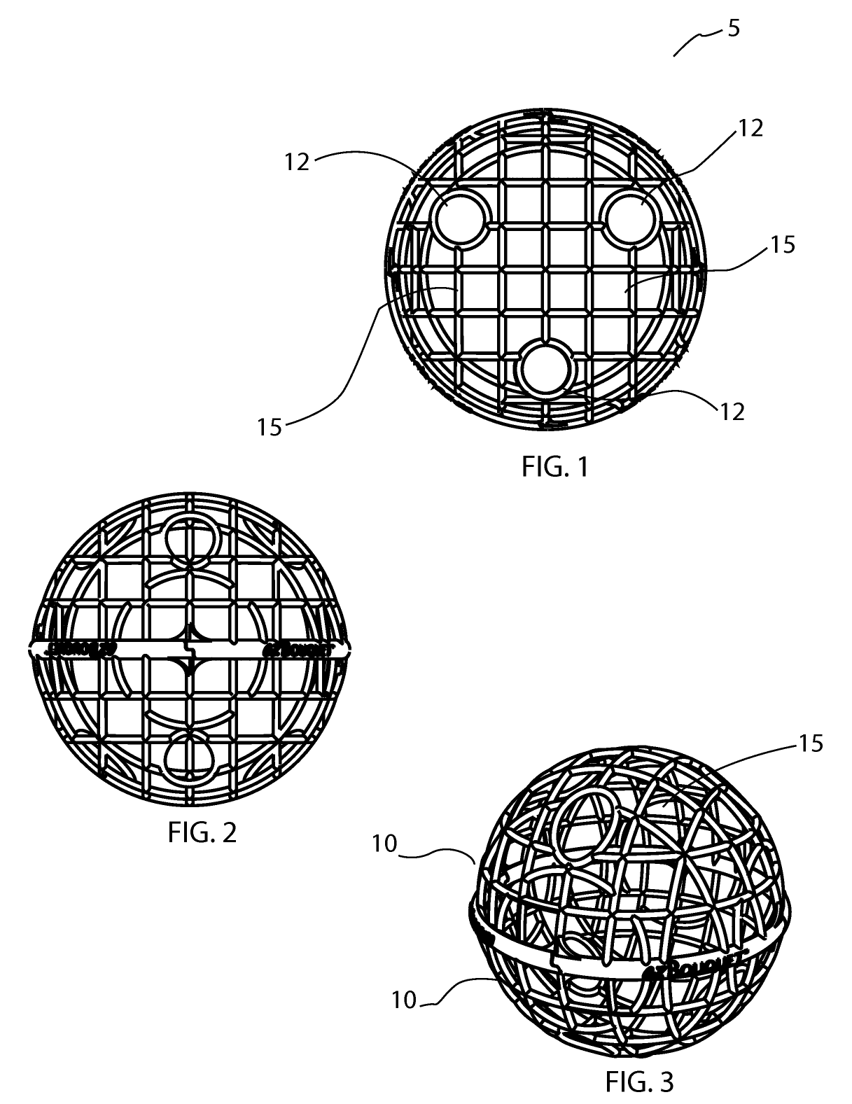

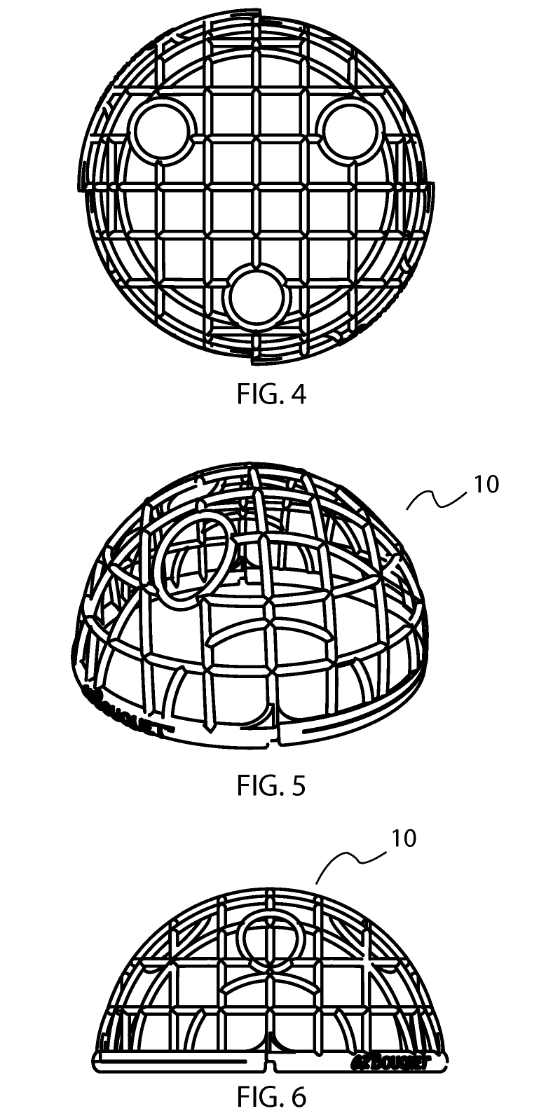

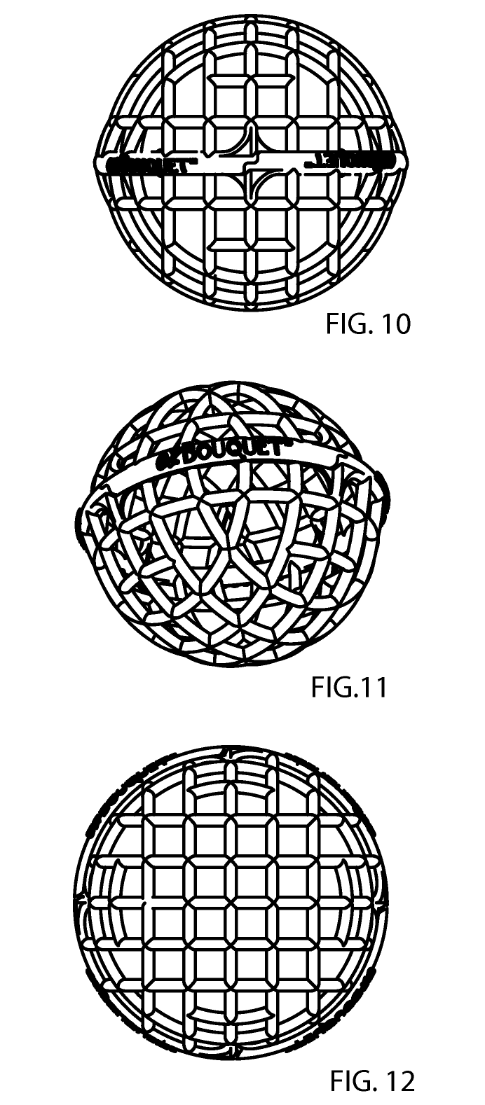

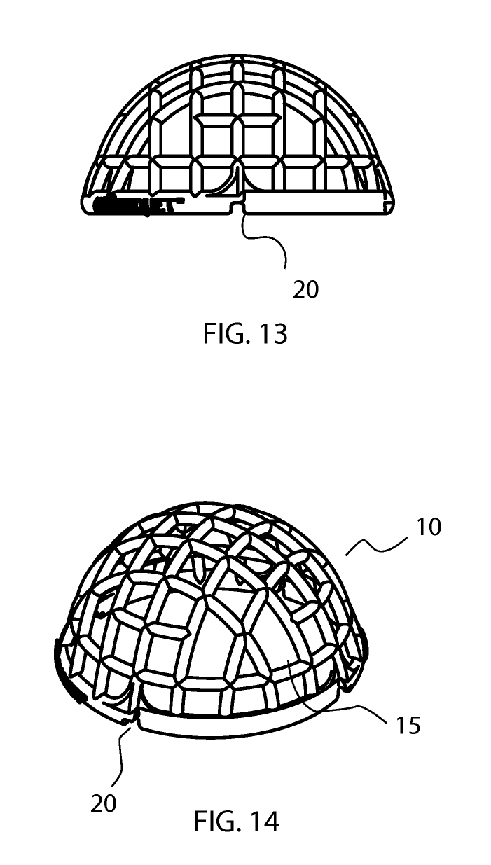

In one embodiment, the spherical apparatus generally 5 is comprised of a pair of dome holders 10 which may be reversibly attached. The surface of dome 10 is shaped to define a plurality of openings 15 that are capable of receiving flower or plant stems passed therethrough. In one preferred embodiment, illustrated by FIGS. 1-3, the surface of dome 10 is a grid-like pattern of openings 15 with a series of annular openings 12. However, it should be noted that the shape, size, and orientation of openings 15 is variable, and the optimal shape, size, and orientation will depend on the flowers to be arranged, the likely arrangement configuration desired, the vase or vessel used with the apparatus (if any), and the varied independent needs of the user. FIGS. 10-12 illustrate an embodiment grid shaped apparatus 5, and FIGS. 13 and 14 illustrate a freestanding grid-shaped dome 10, which contain squared openings 15 and lack annular openings 12.

In a preferred embodiment, dome 10 may be reversibly attached to a corresponding dome 10 having symmetrical openings 15. In an alternative embodiment surface openings 15 on corresponding dome 10 are asymmetrical.

In a preferred embodiment, a foam center may be incorporated within spherical apparatus 5. Plant stems may be passed through openings 15 thereafter penetratingly inserted into the foam center. The foam center aids in frictionally stabilizing plant stems. Further, the foam may soaked in water to provide a source of hydration for inserted plants. The utilization of foam enhances the ability to stabilize floral products along the entire circumferential surface of spherical apparatus 5, and thus, apparatus 5 may suspended from a wire, string, or other line to form a decorative floral ball with flowers arranged along the ball's entire surface.

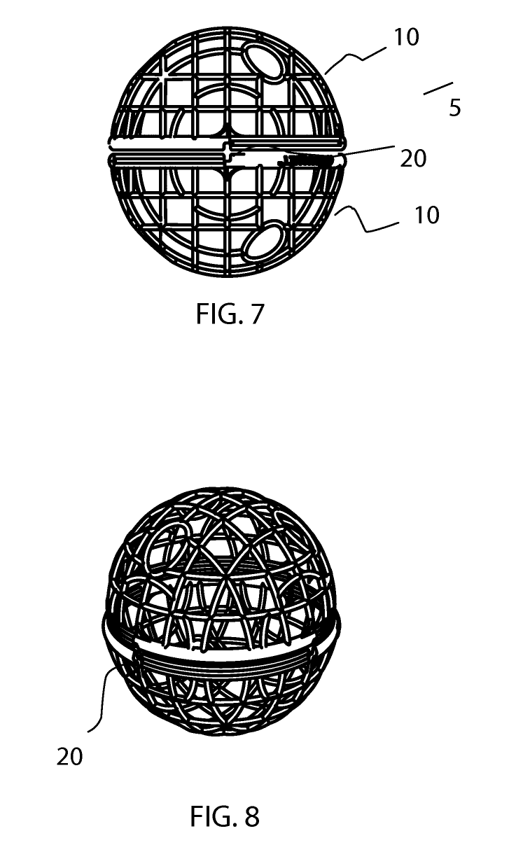

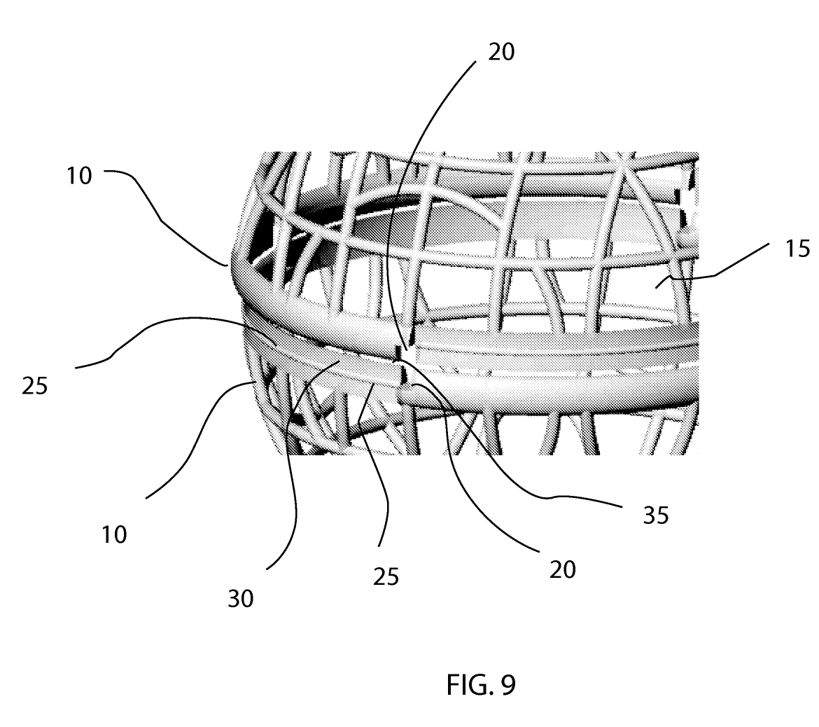

Regarding a mechanism of attachment, FIG. 7-9 illustrate dome halves 10 of spherical apparatus 5 which lock into place through the use of an example push-fit corresponding connections 20 at four intersections along the circumference of domes 10. As illustrated by FIG. 9, the attachment of domes 10 is facilitated through contact with an inner plateau 30 and an outer plateau 35. In one embodiment, inner plateau 30 bears a ridge 25 to facilitate frictional engagement between inner plateau 30 and outer plateau 35.

Regarding the composition of the apparatus, in a preferred embodiment, the apparatus is comprised of plastic, which may be formed through injection molding. However, a number of alternative materials could be utilized including rubber, metal, foam, wire, or other material that will support the weight of flowers when stems are passed through surface openings.

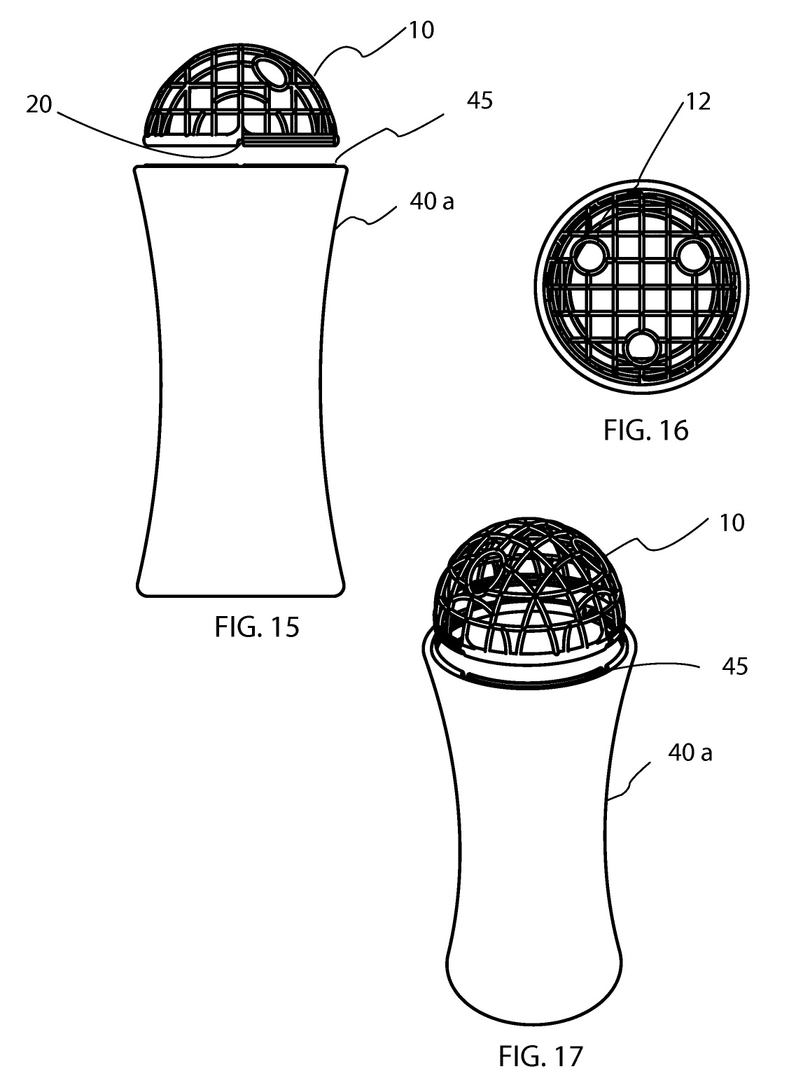

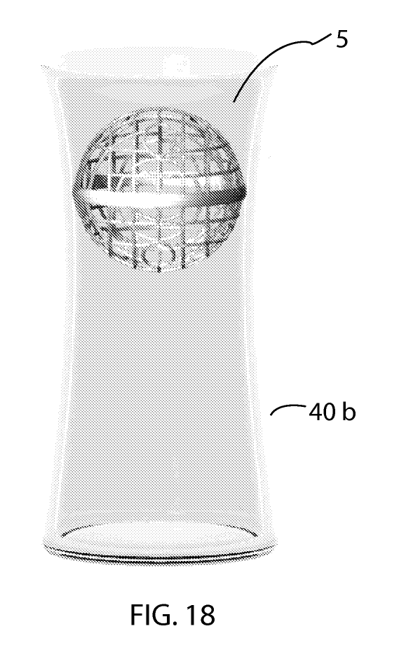

Regarding use, dome 10 may be used singularly, or coupled to a corresponding dome 10 to form spherical apparatus 5. When used singularly, as illustrated by FIGS. 15-17, dome 10 may be reversibly attached to a corresponding connection in the surface of a vase 40a, wherein dome 10 engages connection surface 45 on the lip of vase 40a, such that the concave surface of dome 10 faces the opening of vase 40a. In a preferred embodiment, connection surface 45 attaches to push fit connections 20 and inner plateau 30 or outer plateau 35 in the same manner described and illustrated by FIG. 9 above. Turning now to FIG. 18, when the domes are used together, spherical apparatus 5 may be placed within an appropriately sized vase 40b such that sphere 5 is suitably lodged within vase 40b. Of note, a singular dome 10 may be used in the same fashion and may be placed convexly or concavely in vase 40b. Flowers or other plant stems are passed through openings 15 or annular openings 12 and advanced to the desired location. The stem may be advanced through a second opening 15 or annular opening 12 on the corresponding opposing dome 10 or through a different opening 15 or opening 12 on the same dome 10. Flowers and plants are thereby held in place through contact with dome 10. The process may be repeated to produce a floral arrangement of the users choice.

Regarding the method of arranging plants, a plant holder is provided. The term plant holder, as used herein, refers to an apparatus having a surface shaped to define one or more openings permitting plant of flower stems to be passed therethrough. Two exemplar plant holder embodiments include dome 10, spherical apparatus 5, dome 60, heart shaped apparatus 50, and ring shaped apparatus 10c. The holder is next placed in a chosen vessel, and the user selects the plants to be arranged. The user next inserts at least a portion of the plant stems through one or more openings 15 or annular openings 12 and advances the plant to desired location. The plant is maintained in position through contact with one or more points on the surface of spherical apparatus 5 or dome 10. In an alternative method, the spherical apparatus 5 embodiment holder is first filled with a foam ball. Next, stems are passed through openings 15 or annular openings 12, and thereafter, the stem is penetratingly inserted through the foam ball and advanced to the desired location. The plant is maintained in position through frictional contact with openings 15 or 12, or the foam ball, or any in combination. Thus the optional ball further aids in arrangement stability, and will further aid in plant hydration where the foam ball is itself hydrated by soaking with water prior to placing it within said spherical apparatus 5.

Alternatively, a foam center may be enclosed within spherical apparatus 5. A stem may be advanced through an opening 15 and penetratingly inserted into the foam center, whereby said stem is held in place through frictional engagement with the foam center. In an additional step, the foam center is hydrated prior to placing it within spherical apparatus 5.

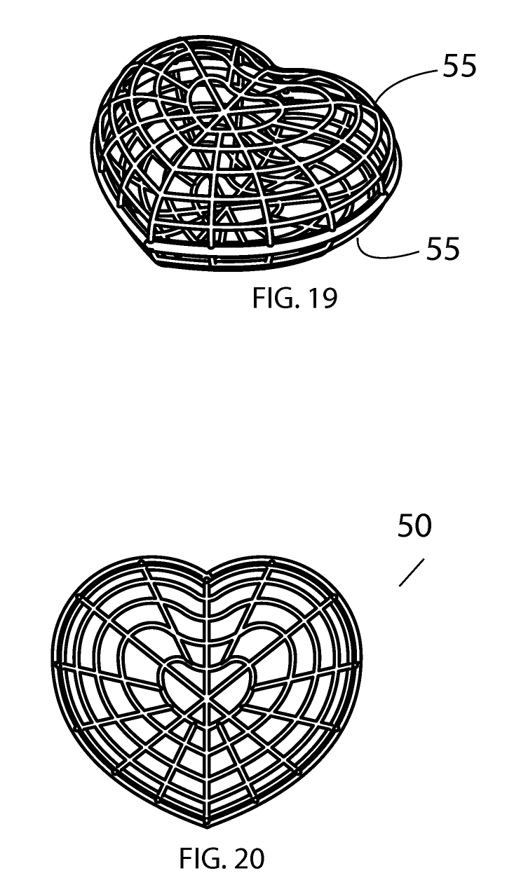

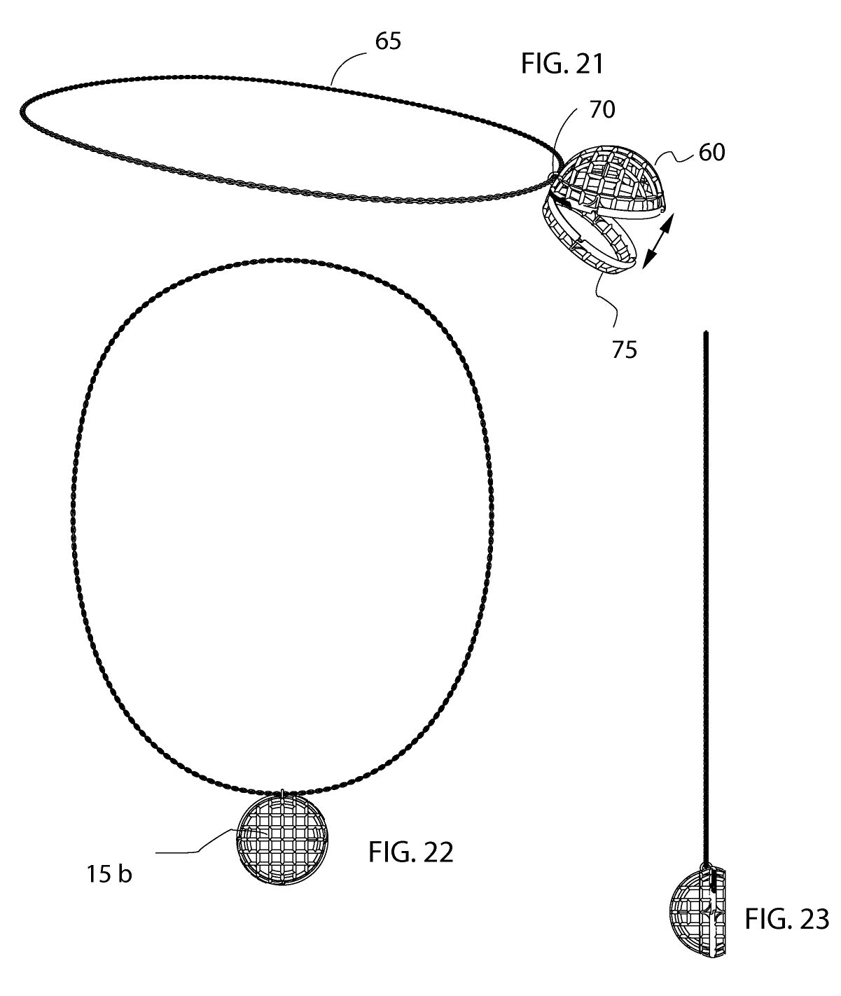

A number of alternative creative apparatus shapes may be adopted. For example, FIGS. 19-20 illustrate an embodiment heart-shaped apparatus 50 wherein each corresponding half 55 may be fitted together utilizing an example mechanism of attachment as described above. An embodiment necklace as illustrated by FIGS. 21-23, may be formed by providing a dome 60 which is affixed to a necklace 65 by eyelet 70. As illustrated by FIG. 21, dome 60 may be hingably coupled to ring 75 wherein dome 60 and ring 75 may be reversibly closed and frictionally secured together. In an alternative embodiment, dome 60 and ring 75 are hingably coupled. Dome 60 and ring 75 may be opened by pulling each in an opposite direction. Flowers may be placed within spaces 15b and arranged according to the user's preferences. By example only, a useful size for dome 60 has been found to be 2.25 inches in diameter.

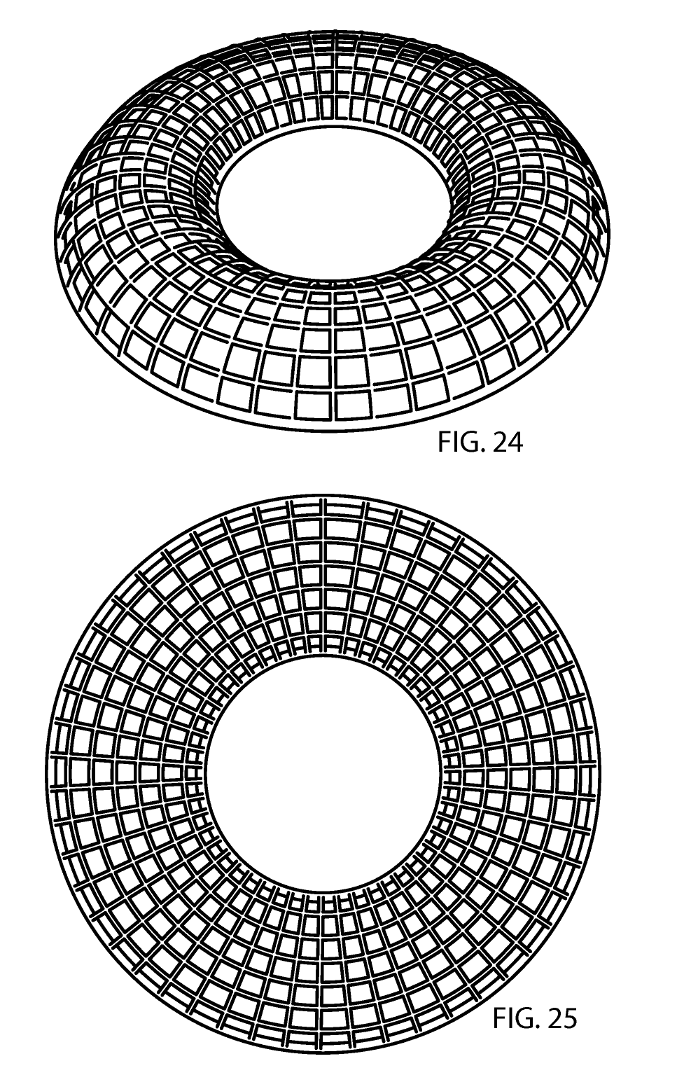

As illustrated by FIGS. 24-25, in lieu of dome 10, a ringed half 10c may be utilized. A pair of corresponding ringed halves may be placed together to form torus-shaped apparatus. Either ring half 10c or a torus-shaped apparatus may be used to form a decorative wreath when flowers are passed through openings 15c. Torus-shaped apparatus 5c may be secured as described more fully above, or through an alternative means. As described more fully above, foam may be enclosed within a torus-shaped apparatus.

It should be noted that the term flowers has been used herein as an example only, and any plant may be placed or arranged through or within the present invention. It should additionally be noted that the term vessel has been used herein to include any container which may hold plants or flowers, the most common vessel for such purposes being a vase. Additionally, the term floral holder has been used to describe various embodiments of the invention, however, it should be noted that the present invention is not limited to the decorative use of flowers only.

Although the present invention has been described with reference to the preferred embodiments, it should be understood that various modifications and variations can be easily made by those skilled in the art without departing from the scope and spirit of the invention. Accordingly, the foregoing disclosure should be interpreted as illustrative only and is not to be interpreted in a limiting sense. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. A plant arranging apparatus comprising: a plant holder having a surface, wherein the surface of said holder is defined by a plurality of openings, wherein said holder may be placed in a vessel and one or more plants positioned, wherein at least a portion of said plants stems are passed through said one or more said openings, wherein said plants are relatively held in position through contact with said holder.

2. The apparatus according to claim 1, wherein said holder is spherically shaped.

3. The apparatus according to claim 2, wherein said surface of said spherically shaped holder is shaped to define a grid pattern.

4. The apparatus according to claim 1, wherein said holder is shaped to define a dome.

5. The apparatus according to claim 4, wherein said surface of said dome-shaped holder is shaped to define a grid pattern.

6. The apparatus according to claim 1, wherein said holder comprises a pair of domed members, said members capable of being reversibly coupled, wherein the surface of said holders is defined by a plurality of openings, wherein said pair of domed holders may be placed in a vessel and one or more plants positioned, wherein at least a portion of said plants stems are passed through said one or more openings, wherein the plants are relatively held in position through contact with said dome members.

7. The apparatus according to claim 6, wherein said surface of said domed members is shaped to define a grid pattern.

8. The apparatus according to claim 1, wherein said holder may be worn as an adornment and one or more plants positioned, wherein at least a portion of said plants stems are passed through said one or more said openings, wherein the plants are relatively held in position through contact with said holder.

9. The apparatus according to claim 2, further comprising a vase, said vase having an internal void, wherein said spherically shaped holder is disposed within the internal void of said vase, wherein at least a portion of said plants stems are passed through said one or more openings, wherein the plants are relatively held in position through contact with said holder.

10. The apparatus according to claim 5, further comprising a vase, said vase having an internal void, wherein said dome-shaped holder is disposed within the internal void of said vase, wherein at least a portion of said plants stems are passed through said one or more openings, wherein the plants are relatively held in position through contact with said holder.

11. A plant arranging apparatus comprising: a spherically shaped plant holder said holder defined by a plurality of openings, wherein said holder may be disposed within a vessel and one or more plants positioned, wherein at least a portion of said plants stems are passed through said one or more said openings, wherein said plants are relatively held in position through contact with said holder.

12. A method of arranging plants comprising the steps of: providing a plant holder with a surface shaped to define one or more openings through said surface; placing said holder in a chosen vessel; selecting plants to be arranged; inserting at least a portion of said plant stems through one or more openings of said holder, wherein said plant is maintained in position through contact with one or more points on said holder's surface.

13. The method according to claim 12, wherein said plant holder is spherically shaped.

14. The method according to claim 13, further comprising the steps of: placing a foam ball within the center of said spherically shaped plant holder; penetratingly inserting at least a portion of said plant stem into said foam ball, wherein said stem is further maintained in position through frictional contact with said foam ball.

15. The method according to claim 12, wherein said plant holder is dome shaped.
